(19) United States
(12) Patent Application Publication
(10) Pub. No.: US 2023/0342801 A1
(43) Pub. Date: Oct. 26, 2023

(54) SUPPLY CHAIN MANAGEMENT SYSTEM

(71) Applicant: Benjamin D. Korpiel, Hickory, NC (US)

(72) Inventor: Benjamin D. Korpiel, Hickory, NC (US)

(21) Appl. No.: 18/134,484

(22) Filed: Apr. 13, 2023

Related U.S. Application Data
(60) Provisional application No. 63/334,035, filed on Apr. 22, 2022.

(51) Int. Cl. G06Q 30/0208; G06Q 10/0834

(52) U.S. Cl. CPC G06Q 30/0208; G06Q 10/08345

(57) ABSTRACT

A computer-implemented method includes: receiving load requests from devices of shippers, each load request including a shipper identifier, an origin location, and a destination location, storing each load request in a database; receiving a first load acceptance message from a device of a first carrier; enrolling the first carrier; receiving a second load acceptance message from a device of a second carrier; storing and associating a credit with the first carrier; receiving a third load acceptance message from the first carrier device; modifying the third rate by increasing the third rate to an enhanced third rate.

### BACKGROUND

### 1. Field

This disclosure relates generally to supply chain management and, in non-limiting embodiments or aspects, to systems, methods, and computer program products for improving supply chain management.

### 2. Technical Considerations

Broker systems are important in the supply chain, as they assist in matching shippers owning goods that need to be shipped with carriers having the trucks and/or other equipment to move those goods. Broker systems bid on loads submitted by shippers, and for those loads won by the broker system, the broker system arranges for a carrier to make the shipments. Broker systems profit in the margin between the rate agreed upon with the shipper and the rate agreed upon with the trucker. This introduces a certain degree of risk to the broker system, as bids between shipper and broker system are often completed before a carrier is secured.

Especially in the recent environment, there are commonly more loads to be shipped than there are carriers to move those loads. However, the practice of broker systems is outdated, such that bids made to shippers and arrangements made with carriers are made in an unpredictable and inefficient manner. Improvements in the computing technology associated with broker systems in making bids and arranging carriers is desirable.

### SUMMARY

According to some non-limiting embodiments or aspects, computer-implemented method includes: receiving, with at least one processor, a plurality of load requests from a plurality of devices associated with a plurality of shippers, each load request of the plurality of load requests including a shipper identifier, an origin location, and a destination location, where the plurality of load requests include a first load, a second load, and a third load; storing, with a least one processor, each load request in a load database; receiving, with at least one processor, a first load acceptance message from a device associated with a first carrier, the first load acceptance message including a first carrier identifier, a first load identifier, and a first rate; automatically enrolling the first carrier in a first program, where enrolling the first carrier includes storing a first incentive identifier associated with the first carrier in an incentive database; receiving, with at least one processor, a second load acceptance message from a device associated with a second carrier different from the first carrier, the second load acceptance message including a second carrier identifier, a second load identifier, the first incentive identifier associated with the first carrier, and a second rate; in response to receiving the second load acceptance message including the first incentive identifier, storing and associating, with at least one processor, at least one credit with the first carrier in the incentive database; receiving, with at least one processor, a third load acceptance message from the device associated with the first carrier, the third load acceptance message including the first carrier identifier, a third load identifier, and a third rate; in response to receiving the third load acceptance message and based on the at least one credit associated with the first carrier in the incentive database, modifying, with at least one processor, the third rate by increasing the third rate to an enhanced third rate.

In some non-limiting embodiments or aspects, the computer-implemented method may further include: receiving, with at least one processor, a fourth load acceptance message from a device associated with a third carrier different from the first carrier, the fourth load acceptance message including a third carrier identifier, a fourth load identifier, the first incentive identifier associated with the first carrier, and a fourth rate; in response to receiving the fourth load acceptance message including the first incentive identifier, storing and associating, with at least one processor, at least one credit with the first carrier in the incentive database.

In some non-limiting embodiments or aspects, the method may further include: automatically enrolling the second carrier in the first program, where enrolling the second carrier includes storing a second incentive identifier associated with the second carrier in the incentive database; receiving, with at least one processor, a fourth load acceptance message from a device associated with a third carrier different from the second carrier, the fourth load acceptance message including a third carrier identifier, a fourth load identifier, the second incentive identifier, and a fourth rate; in response to receiving the fourth load acceptance message including the second incentive identifier, storing and associating, with at least one processor, at least one credit with the second carrier in the incentive database.

In some non-limiting embodiments or aspects, the third rate may be increased to the enhanced third rate according to: A=P(1+r/n)^{nt}, where A is the enhanced third rate, P is the third rate, r is an incentive rate, n is a credit per load, and t is a number of loads referred by the first carrier.

In some non-limiting embodiments or aspects, storing each load request in a load database may further include automatically uploading each load request to an online portal accessible to devices of a plurality of carriers.

In some non-limiting embodiments or aspects, the computer-implemented method may further include: in response to a first vehicle of the first carrier entering a geofence area associated with a first destination location associated with the first load, receiving, with at least one processor, location data of the first vehicle, where the first vehicle includes a location tracking device; in response to receiving the location data of the first vehicle, determining, with at least one processor, the first destination location; based on the first destination location, querying, with at least one processor, the load database to determine at least one load request of the plurality of load requests having an origin location most proximate to the first destination location, where the at least one load request having the origin location most proximate to the first destination location includes the third load; generating, with at least one processor, a load recommendation message including the third load identifier associated with the third load; transmitting, with at least one processor, the load recommendation message to the device associated with the first carrier; and receiving, with at least one processor, the third load acceptance message.

In some non-limiting embodiments or aspects, the at least one processor may display a user interface showing each load request on a broker device, where the method further includes: in response to determining the at least one load request of the plurality of load requests having an origin location most proximate to the first destination location, modifying the user interface to emphasize a display associated with the at least one load request of the plurality of load requests.

In some non-limiting embodiments or aspects, emphasizing the display associated with the at least one load request of the plurality of load requests may include generating and displaying a new user interface containing only the at least one load request of the plurality of load requests.

In some non-limiting embodiments or aspects, the computer-implemented method may further include: determining, with at least one processor, a travel distance between an origin location of the third load and the first destination location; retrieving, with at least one processor, a real-time fuel rate and a fuel efficiency of the first vehicle; based on the travel distance, the real-time fuel rate, and the fuel efficiency of the first vehicle, determining, with at least one processor, a deadhead cost associated with the first vehicle traveling from the first destination location to the origin location of the third load; and automatically updating, with at least one processor, at least one of the third rate and the enhanced third rate based on the determined deadhead cost.

In some non-limiting embodiments or aspects, the method may further include: for each of the at least one load request having an origin location most proximate to the first destination location: determining, with at least one processor, a deadhead cost associated with the first vehicle traveling from the first destination location to the origin location of each of the at least one load request having an origin location most proximate to the first destination location; and comparing each deadhead cost to a threshold related to a load price for the corresponding load request; for each load request in which the threshold is not satisfied, inserting the load request into the load recommendation message.

In some non-limiting embodiments or aspects, storing each load request in a load database may further include automatically uploading each load request to an online portal accessible to devices of a plurality of carriers to cause each of the loads to be displayed on a second user interface of the device associated with the first carrier, where the method further includes: in response to determining the at least one load request of the plurality of load requests having an origin location most proximate to the first destination location, modifying the second user interface to emphasize a display associated with the at least one load request of the plurality of load requests.

In some non-limiting embodiments or aspects, where the emphasized display associated with the at least one load request of the plurality of load requests may enable the first carrier to interact with the second user interface to accept the at least one load request of the plurality of load requests.

According to some non-limiting embodiments or aspects, a system includes at least one processor programmed or configured to execute any of the methods described herein.

According to some non-limiting embodiments or aspects, a computer program process includes at least one non-transitory computer-readable medium including one or more instructions that, when executed by at least one processor, cause the at least one processor to execute any of the methods described herein.

According to some non-limiting embodiments or aspects, a computer-implemented method includes: receiving, with at least one processor, a bid request message from a shipper device associated with at least one shipper, where the bid request message identifies a plurality of loads needing shipped over a time period, where each load includes a shipper identifier, an origin location, and a destination location; in response to receiving the bid request message, automatically forecasting, with at least one processor, at least one enhanced rate due to the first carrier based on the at least one credit associated with the first carrier in the incentive database as described herein; for each load of the plurality of loads in the bid request message from the shipper device, generating, with at least one processor, at least one proposed rate based on the forecasted at least one enhanced rate due to the first carrier; and transmitting, with at least one processor, a bid response message associating each of the at least one proposed rate with the corresponding to each load of the plurality of loads.

According to some non-limiting embodiments or aspects, a system includes at least one processor programmed or configured to: receive a bid request message from a shipper device associated with at least one shipper, where the bid request message identifies a plurality of loads needing shipped over a time period, where each load includes a shipper identifier, an origin location, and a destination location in response to receiving the bid request message, automatically forecast at least one enhanced rate due to the first carrier based on the at least one credit associated with the first carrier in the incentive database as described herein; for each load of the plurality of loads in the bid request message from the shipper device, generate at least one proposed rate based on the forecasted at least one enhanced rate due to the first carrier; and transmit a bid response message associating each of the at least one proposed rate with the corresponding to each load of the plurality of loads.

According to some non-limiting embodiments or aspects, a computer program process includes at least one non-transitory computer-readable medium including one or more instructions that, when executed by at least one processor, cause the at least one processor to: receive a bid request message from a shipper device associated with at least one shipper, where the bid request message identifies a plurality of loads needing shipped over a time period, where each load includes a shipper identifier, an origin location, and a destination location; in response to receiving the bid request message, automatically forecast at least one enhanced rate due to the first carrier based on the at least one credit associated with the first carrier in the incentive database as described herein; for each load of the plurality of loads in the bid request message from the shipper device, generate at least one proposed rate based on the forecasted at least one enhanced rate due to the first carrier; and transmit a bid response message associating each of the at least one proposed rate with the corresponding to each load of the plurality of loads.

Further embodiments or aspects are set forth in the following numbered clauses:

Clause 1: A computer-implemented method; comprising: receiving, with at least one processor, a plurality of load requests from a plurality of devices associated with a plurality of shippers, each load request of the plurality of load requests comprising a shipper identifier, an origin location, and a destination location, wherein the plurality of load requests comprise a first load, a second load, and a third load; storing, with a least one processor, each load request in a load database; receiving, with at least one processor, a first load acceptance message from a device associated with a first carrier, the first load acceptance message comprising a first carrier identifier, a first load identifier; and a first rate; automatically enrolling the first carrier in a first program, wherein enrolling the first carrier comprises storing a first incentive identifier associated with the first carrier in an incentive database; receiving, with at least one processor, a second load acceptance message from a device associated with a second carrier different from the first carrier, the second load acceptance message comprising a second carrier identifier, a second load identifier, the first incentive identifier associated with the first carrier, and a second rate; in response to receiving the second load acceptance message comprising the first incentive identifier, storing and associating, with at least one processor, at least one credit with the first carrier in the incentive database; receiving, with at least one processor, a third load acceptance message from the device associated with the first carrier, the third load acceptance message comprising the first carrier identifier, a third load identifier, and a third rate; in response to receiving the third bad acceptance message and based on the at least one credit associated with the first carrier in the incentive database, modifying, with at least one processor, the third rate by increasing the third rate to an enhanced third rate.

Clause 2: The computer-implemented method of clause 1, further comprising: receiving, with at least one processor, a fourth bad acceptance message from a device associated with a third carrier different from the first carrier, the fourth bad acceptance message comprising a third carrier identifier, a fourth load identifier, the first incentive identifier associated with the first carrier, and a fourth rate; in response to receiving the fourth bad acceptance message comprising the first incentive identifier, storing and associating, with at least one processor, at least one credit with the first carrier in the incentive database.

Clause 3: The computer-implemented method of clause 1 or 2, further comprising: automatically enrolling the second carrier in the first program, wherein enrolling the second carrier comprises storing a second incentive identifier associated with the second carrier in the incentive database; receiving, with at least one processor, a fourth bad acceptance message from a device associated with a third carrier different from the second carrier, the fourth load acceptance message comprising a third carrier identifier, a fourth bad identifier, the second incentive identifier, and a fourth rate; in response to receiving the fourth bad acceptance message comprising the second incentive identifier, storing and associating, with at least one processor, at least one credit with the second carrier in the incentive database.

Clause 4: The computer-implemented method of claim 1, wherein the third rate is increased to the enhanced third rate according to: A=P(1+r/n)^{nt}, wherein A is the enhanced third rate, P is the third rate, r is an incentive rate, n is a credit per load, and t is a number of loads referred by the first carrier.

Clause 5: The computer-implemented method of any of clauses 1-4, wherein storing each load request in a load database further comprises automatically uploading each load request to an online portal accessible to devices of a plurality of carriers.

Clause 6: The computer-implemented method of any of clauses 1-5, further comprising: in response to a first vehicle of the first carrier entering a geofence area associated with a first destination location associated with the first load, receiving, with at least one processor, location data of the first vehicle, wherein the first vehicle comprises a location tracking device; in response to receiving the location data of the first vehicle, determining, with at least one processor, the first destination location; based on the first destination location, querying, with at least one processor, the load database to determine at least one load request of the plurality of load requests having an origin location most proximate to the first destination location, wherein the at least one load request having the origin location most proximate to the first destination location comprises the third load; generating, with at least one processor, a load recommendation message comprising the third load identifier associated with the third load; transmitting, with at least one processor, the load recommendation message to the device associated with the first carrier; and receiving, with at least one processor, the third load acceptance message.

Clause 7: The computer-implemented method of clause 6, wherein the at least one processor displays a user interface showing each load request on a broker device, wherein the method further comprises: in response to determining the at least one load request of the plurality of load requests having an origin location most proximate to the first destination location, modifying the user interface to emphasize a display associated with the at least one load request of the plurality of load requests.

Clause 8: The computer-implemented method of clause 6 or 7, wherein emphasizing the display associated with the at least one load request of the plurality of load requests comprises generating and displaying a new user interface containing only the at least one load request of the plurality of load requests.

Clause 9: The computer-implemented method of any of clauses 6-8, further comprising: determining, with at least one processor, a travel distance between an origin location of the third load and the first destination location; retrieving, with at least one processor, a real-time fuel rate and a fuel efficiency of the first vehicle; based on the travel distance, the real-time fuel rate, and the fuel efficiency of the first vehicle, determining, with at least one processor, a deadhead cost associated with the first vehicle traveling from the first destination location to the origin location of the third load; and automatically updating, with at least one processor, at least one of the third rate and the enhanced third rate based on the determined deadhead cost.

Clause 10: The computer-implemented method of any of clauses 6-9, further comprising: for each of the at least one load request having an origin location most proximate to the first destination location: determining, with at least one processor, a deadhead cost associated with the first vehicle traveling from the first destination location to the origin location of each of the at least one load request having an origin location most proximate to the first destination location; and comparing each deadhead cost to a threshold related to a load price for the corresponding load request; for each load request in which the threshold is not satisfied, inserting the load request into the load recommendation message.

Clause 11: The computer-implemented method of any of clauses 6-10, wherein storing each load request in a load database further comprises automatically uploading each load request to an online portal accessible to devices of a plurality of carriers to cause each of the loads to be displayed on a second user interface of the device associated with the first carrier, wherein the method further comprises: in response to determining the at least one load request of the plurality of load requests having an origin location most proximate to the first destination location, modifying the second user interface to emphasize a display associated with the at least one load request of the plurality of load requests.

Clause 12: The computer-implemented method of clause 11, wherein the emphasized display associated with the at least one load request of the plurality of load requests enables the first carrier to interact with the second user interface to accept the at least one load request of the plurality of load requests.

Clause 13: A system comprising at least one processor programmed or configured to execute any of the methods of clauses 1-12.

Clause 14: A computer program process comprising at least one non-transitory computer-readable medium including one or more instructions that, when executed by at least one processor, cause the at least one processor to execute any of the methods of clauses 1-12.

Clause 15: A computer-implemented method, comprising: receiving, with at least one processor, a bid request message from a shipper device associated with at least one shipper, wherein the bid request message identifies a plurality of loads needing shipped over a time period, wherein each load comprises a shipper identifier, an origin location, and a destination location; in response to receiving the bid request message, automatically forecasting, with at least one processor, at least one enhanced rate due to the first carrier based on the at least one credit associated with the first carrier in the incentive database as described in clause 1; for each load of the plurality of loads in the bid request message from the shipper device, generating, with at least one processor, at least one proposed rate based on the forecasted at least one enhanced rate due to the first carrier; and transmitting, with at least one processor, a bid response message associating each of the at least one proposed rate with the corresponding to each load of the plurality of loads.

Clause 16: A system comprising at least one processor programmed or configured to: receive a bid request message from a shipper device associated with at least one shipper, wherein the bid request message identifies a plurality of loads needing shipped over a time period, wherein each load comprises a shipper identifier, an origin location, and a destination location in response to receiving the bid request message, automatically forecast at least one enhanced rate due to the first carrier based on the at least one credit associated with the first carrier in the incentive database as described in clause 13; for each load of the plurality of loads in the bid request message from the shipper device, generate at least one proposed rate based on the forecasted at least one enhanced rate due to the first carrier; and transmit a bid response message associating each of the at least one proposed rate with the corresponding to each load of the plurality of loads.

Clause 17: A computer program process comprising at least one non-transitory computer-readable medium including one or more instructions that, when executed by at least one processor, cause the at least one processor to: receive a bid request message from a shipper device associated with at least one shipper, wherein the bid request message identifies a plurality of loads needing shipped over a time period, wherein each load comprises a shipper identifier, an origin location, and a destination location; in response to receiving the bid request message, automatically forecast at least one enhanced rate due to the first carrier based on the at least one credit associated with the first carrier in the incentive database as described in claim 14; for each load of the plurality of loads in the bid request message from the shipper device, generate at least one proposed rate based on the forecasted at least one enhanced rate due to the first carrier; and transmit a bid response message associating each of the at least one proposed rate with the corresponding to each load of the plurality of loads.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for supply chain management, according to non-limiting embodiments or aspects;

FIG. 2 is a schematic diagram of a system for supply chain management, according to non-limiting embodiments or aspects;

FIG. 3 is a schematic diagram of a map tracking a vehicle, according to non-limiting embodiments or aspects;

FIG. 4 is a user interface, according to non-limiting embodiments or aspects;

FIGS. 5A-5C are modified user interfaces, according to non-limiting embodiments or aspects; and

FIG. 6 illustrates example components of a device used in connection with non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

### Definitions

For the sake of this proposal the language below will describe terminology used in the freight business.
Carrier: A truck driver that is either an owner-operator or a driver for an external trucking company.
Owner-Operator: A person who owns his own truck and drives for himself.
Lane: A specific route based on origin and destination.
Equipment: The type of trailer a carrier is hauling:
   Reefer: Refrigerated trailer used for hauling climate controlled goods.
   Van: An enclosed dry load trailer.
   Flatbed: An open, dry load trailer.
   Conestoga: a flatbed trader with collapsible tarp roofs.
Customer: The entity providing goods to be hauled. The term customer is used interchangeably with “shipper” and both refer to the entity owning goods to be shipped.
Broker: Entity connecting customer loads to carriers.
Spot Bids: A silent auction created by customer, bid on by brokers, to determine the price required to haul goods in a select lane. Often referred to as bids or spots.
Rate: The price of hauling the goods in a given lane. A customer gives a rate to a broker and broker gives lower rate to carrier to profit the margin.
Market rate: Current rate for specific lanes influenced by fuel prices, and inflation.
Linehaul: Fixed rate for using the truck to haul goods. Often added with fuel surcharge to give complete rate.
Fuel Surcharge: Variable rate given to compensate for the price of fuel. This is typically fixed and different customers provide different fuel rates.
Posting: An available lane posted to a universal board (e.g., on a website) where carriers can see available loads needing to be hauled,
Board: A universal website consisting of available loads in any lane on a given day.
Load: A set amount of goods that need to be hauled in a given lane.
Book a Load: Carrier and broker agree to set rate and carrier hauls bad.
Rate Confirmation: A contract sent by the broker to the carrier to sign, acknowledging and agreeing to the details of the load.

The present disclosure describes an incentive structure to increase the inflow of referrals from potential carriers to compound their use frequency with the company and to decrease brokerage negotiation resulting.

Brokerage practices are outdated and lack significant automation. Existing protocols of a broker include evaluating available loads that need to go for the day on their internal company software, posting them up to universal bad boards and posting the rate they are willing to pay to the carrier. A carrier will see the bad and engage the broker in order to negotiate for a higher rate. The broker is only receiving a set amount from the customer so it is the broker system's job to ensure the rate generated for the carrier is lower than the rate the broker is receiving from the customer.

Negotiation for rates is an art form among brokers. It is common practice for a carrier to book a load in a set lane and to then ask for that same rate for the same lane a few days later on a separate load. This is ideal because the broker and the carrier are in agreement for long term loads. It is less cold calling and negotiation a broker has to do in order to get his load covered. Cold calling and looking for a carrier to haul a load before it is picked up can create a stressful work environment. The more times a load misses, the customer-broker relationships are weakened. Regular carriers and improved broker systems for a broker are a needed for that reason. The more regular carriers a broker has and/or the better the broker system, the more loads that can be completed with less work and increasing commission.

The rates given to the broker by the carrier as counter offers can range from reasonable to absurd. The rates are determined by multiple factors including but not limited to, fuel prices, inflation, insurance prices, and mechanic fees. Trends in the market are similar to that of the stock market and are often given at a rate per mile. Rates will fluctuate based on exterior factors but are not nearly as volatile as the stock market due to limited contributing factors. Depending on the brokerage firm, a broker has a standard target margin. It is the role of the broker system to identify a carrier to haul the load below the bid rate to profit the margin. Negotiation and finding the right carrier is ideal for these situations.

The proposed disclosure has goals to improve current broker systems for matching carriers with customers having loads requiring shipment and implementing supply chain incentive programs, in turn increasing margins, decreasing brokerage stress, increasing carrier use, and expediting and making more efficient carrier-broker communication. The disclosure includes incentivizing a carrier for referrals to the broker system to haul a load. The referred carrier would communicate with the broker system, by communicating the carrier/referring carrier identifier such that the referring carrier would automatically receive an increase in his rate for the next load he hauls from the broker system.

Every carrier may have a specific identification, his motor carrier (MC) number. This is typically a 6 or 7 digit unique identifier that is specific only to his carrier company. An owner operator will have one MC and a trucking company with many trucks will also only have one MC. An MC is specific to a company rather than a truck. It is this MC number that the system will use to create links between carriers for incentive. This unique identifier may be used to identify the referral carrier in order to initiate the automated transfer of benefit to that referral carrier. Each truck may also comprise a unique identifier (e.g., a vehicle identifier). Each vehicle may be associated with an MC.

Using the MC numbers may allow brokers to determine which carriers are entitled to incentives based on the MC numbers they have referred to haul loads. Brokerage firms may have internal software that outline all details of specific lanes and historical data therein. These software programs allow broker systems to make more informed decisions on what to pay carriers and what carriers were paid for hauling that lane in the past. It is this software that may be used in the course of executing the system.

The system may be executed by linking MC numbers with one another and automatically applying incentives based on what is earned. The internal brokerage software may hold the data and compound it based on a predetermined time period (e.g., week, month, quarter, year).

Non-limiting embodiments or aspects described herein relate to systems, methods, and computer program products improving a supply chain system. Non-limiting embodiments or aspects improve existing broker systems for aligning loads with carriers by automatically implementing the supply chain incentive program. The system may automatically enroll carriers using a unique identifier associated with each enrolled carriers. In response to receiving load acceptance messages comprising a carrier identifier in a referral data entry, the system may automatically generate, store, and associate at least one credit in an incentive database with the carrier identified in the referral data entry. In response to receiving a load acceptance message from that carrier identified in the referral data entry, the broker system may automatically modify the rate to an enhanced rate for the carrier based on the at least one credit stored in the incentive database. In this way, the system automatically executes the incentive program having customized rates for referring carriers.

Non-limiting embodiments or aspects utilize location tracking devices of vehicles and their co-action with a geofence area associated with the destination location of the vehicles. When triggered by a first vehicles entering the geofence area, the system may determine at least one a load request has an origin location most proximate to the destination location of the first vehicle and automatically generate a load recommendation message to be transmitted to the device of the carrier. This feature involving the tracking devices and geofence area more conserve processing resources associated with matching carriers to loads.

Based on determining the load requests having an origin location most proximate to the destination location of the first vehicle, the user interface (e.g., of the broker system and/or the carrier device) may be modified to emphasize the most proximate loads. This may involve generating and displaying a new user interface containing only the recommended, proximate loads. The broker and/or the carrier may engage with the emphasized features of the modified user interface to accept the new load.

The system may automatically determine deadhead cost (lost costs associated with driving from the destination location of the first vehicle to the origin location) based on the destination location of the first vehicle and the origin location most proximate to the destination location. Based on the deadhead costs and the load price corresponding to the load, the broker system may determine whether each load request satisfies a threshold (thus making the carrier-load match unprofitable) and only recommend loads not satisfying the threshold. The system may automatically update the rate based on the deadhead cost.

Non-limiting embodiments or aspects described herein relate to systems, methods, and computer program products forecasting a long-term bid rate. The broker system used to make automated bids on load requests from shippers leverages the incentive database described therein to more efficiently and accurately generate bids. The system may forecast the enhanced rate due to carriers enrolled in the incentive program to generate the more efficient and accurate proposed rate, which may be transmitted to the shipper device. Based on incorporation of the data from the incentive database during the bid process executed by the broker system, the broker system is improved in its ability to automatically generate accurate proposed rates.

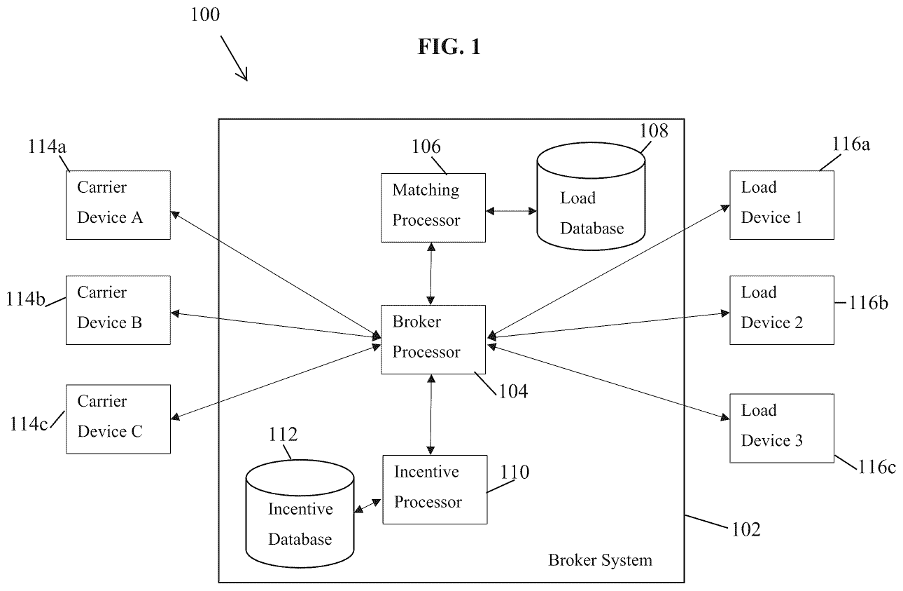

A non-limiting embodiment of a system 100 for managing supply chain is described below and references FIG. 1.

A plurality of load requests may be received by a broker system 102 from a plurality of different shippers. The broker system 102 may comprise a broker processor 104, a matching processor 106, a load database 108, an incentive processor 110, and an incentive database 112.

The load requests may be received by the broker system 102 from load devices 116a-116c, each load device 116a-116c associated with a shipper. The shippers may request a load be transported from an origin location to a destination location.

Each load request may identify the shipper, the origin location, the destination location, a date (e.g., load data). Receipt of the load request can trigger a “silent auction” from a plurality of different broker systems 102, and the load device 116a-116c of the shipper may select broker system 102 with lowest bid.

The broker system 102 may store the load requests in the load database 108. For example, broker system 102 may receive 3 load requests associated with Loads 1-3, and the load database 108 may store the load data associated with Loads 1-3. The load database 108 may also associate and store a load rate with each load and a unique load identifier associated with each load, both of which may be generated by the broker system 102.

The broker system 102 may automatically upload load data associated with loads stored in the load database 108 to website or other portal (e.g., in a mobile application), such that a user interface of a device (e.g., carrier devices 114a-114c) may display the load data (origin and destination location) and other data associated with transporting the load, such as a rate/mile being offered to the carrier to transport the load. Thus, uploading the load data may make the load requests accessible to the carrier devices 114a-114c. In some non-limiting embodiments, the carrier device 114a-114c may communicate with broker system 102 to initiate a rate negotiation for the load.

In some non-limiting examples, carrier device A 114a of Carrier A may engage with broker processor 104 (of the broker system 102) to select Load 1 via a first load acceptance message. The load acceptance message may comprise data fields which include carrier identifier A associated with Carrier A, an identifier of Load 1, and a first rate associated with Load 1. Carrier A device 114a can automatically select book it now or may communicate with broker system 102 regarding load details.

In response to carrier A device 114a selecting Load 1, Carrier A may receive an offer message from the broker processor 104 to enroll in an incentive program, and carrier A device 114a may accept enrollment into the incentive program, or Carrier A may be automatically enrolled in the incentive program based on selecting Load 1.

In response, the incentive processor 110 may generate a unique incentive identifier A associated with Carrier A and assigns incentive identifier A to Carrier A. For example, the motor carrier (MC) number of a carrier may be the carrier's unique identifier. The incentive processor 110 may store incentive identifier A in the incentive database 112 associated with Carrier A. Load data associated with Load 1 may be stored in the incentive database 112 in association with Carrier A in response to Carrier A selecting Load 1 and/or completing Load 1.

Carrier A may complete Load 1 for a first rate.

Carrier A may refer Carrier B (a different carrier). For example, carrier A device 114a may communicate a referral message to carrier B device 114b, which referral message comprises a data field containing incentive identifier A; other referral means are contemplated within scope of this disclosure.

Carrier B device 114b may engage with the broker processor 104 to select Load 2 via a second load acceptance message, wherein the second load acceptance message comprises data fields containing incentive identifier A and includes carrier identifier B, an identifier of Load 2, and a second rate associated with Load 2. In response to the second load acceptance message comprising incentive identifier A, the incentive processor 110 may generate, associate, and store a first credit with Carrier A in the incentive database 112, based on the second load acceptance message identifying Carrier A as referring Carrier B.

Carrier B may complete Load 2 for a second rate.

Carrier A device 114 may engage with the broker processor 104 to select Load 3 via a third load acceptance message, which includes carrier identifier A an identifier of Load 3, and a third rate associated with Load 3. In response to the third load acceptance message containing carrier identifier A, incentive processor 110 may communicate with incentive database 112 to retrieve credit(s) associated with Carrier A.

Based on Carrier A having an associated credit (e.g., the first credit) stored in the incentive database 112, the broker processor 104 may modify the third rate (initially set for Load 3) to form an enhanced third rate, which may be increased from the initial third rate. Carrier A may complete Load 3 for enhanced third rate.

The third rate may be enhanced using any suitable algorithm. For example, the third rate may be enhanced according to the following algorithm: A=P(1+r/n)^{nt}. In this algorithm, A is the enhanced third rate, P is the third rate, r is an incentive rate (e.g., determined by the broker system), n is a credit per load, and t is a number of loads referred by Carrier A.

In some non-limiting embodiments, Carrier C device 114c may engage with the broker processor 104 to select a fourth load (Load 4) via a fourth load acceptance message, wherein the fourth load acceptance message comprises data fields containing incentive identifier A and includes carrier identifier C, an identifier of Load 4, and a fourth rate associated with Load 4. In response to the fourth load acceptance message comprising incentive identifier A, the incentive processor 110 may generate, associate, and store a second credit with Carrier A in the incentive database 112, based on the fourth load acceptance message identifying Carrier A as referring Carrier C.

In some non-limiting embodiments, in response to Carrier B accepting Load 2, Carrier B maybe automatically enrolled by the broker system 102 in the incentive program. In response, the incentive processor 110 may generate a unique incentive identifier B associated with Carrier B and assigns incentive identifier B to Carrier B. For example, the MC number of a carrier may be the carrier's unique identifier. The incentive processor 110 may store incentive identifier B in the incentive database 112 associated with Carrier B. Load data associated with Load 2 may be stored in the incentive database 112 in association with Carrier B in response to Carrier B selecting Load 2 and/or completing Load 2.

In some non-limiting embodiments, Carrier C device 114c may engage with the broker processor 104 to select a fifth load (Load 5) via a fifth load acceptance message, wherein the fifth load acceptance message comprises data fields containing incentive identifier B and includes carrier identifier C, an identifier of Load 5, and a fifth rate associated with Load 5. In response to the fifth load acceptance message comprising incentive identifier B, the incentive processor 110 may generate, associate, and store a credit with Carrier B in the incentive database 112, based on the fifth load acceptance message identifying Carrier B as referring Carrier C,

In another non-limiting example with respect to the incentive program: if the carrier associated with identifier MC 123456 refers identifier MC 123457, identifier MC 123456 may receive a credit (which is automatically stored in incentive database 112) when identifier MC 123457 selects and/or completes a load. If identifier MC 123457 refers identifier MC 123458, identifier MC 123457 may receive a credit (which is automatically stored in incentive database 112), and identifier MC 123456 may not (the incentive goes 1 tier). In this example, each identifier MC is associated with a different carrier.

A non-limiting embodiment of the present disclosure for forecasting a bid rate is described below and references FIG. 1.

The broker system 102 may receive a bid request message from a load device 116a associated with at least one shipper. The bid request message may identify a plurality of loads needing shipped over a time period (e.g., a long-term bid). The long-term bid may have a time period of at least one 1 week, 1 month, 1 quarter, 6 months, 1 year, and the like. Additionally or alternatively, the bid request message may comprise a plurality of loads, such as at least 10 loads, at least 20 loads, at least 50 loads, at least 100 loads, and the like. Each load may include a shipper identifier containing a plurality of loads, an origin location, and a destination location.

In response to receiving the bid request message, the broker system 102 (e.g., the broker processor) may automatically forecast at least one enhanced rate due to a carrier A based on the at least one credit associated with the carrier A in the incentive database 112 as described herein. For each load of the plurality of loads in the bid request message from the load device 116a, the broker system 102 may generate at least one proposed rate based on the forecasted at least one enhanced rate due to carrier A. The broker system 102 may transmit to the load device 116a a bid response message associating each of the at least one proposed rate with the corresponding to each load of the plurality of loads. The load device 116a may accept the proposed rate, decline the proposed rate, and/or modify the proposed rate.

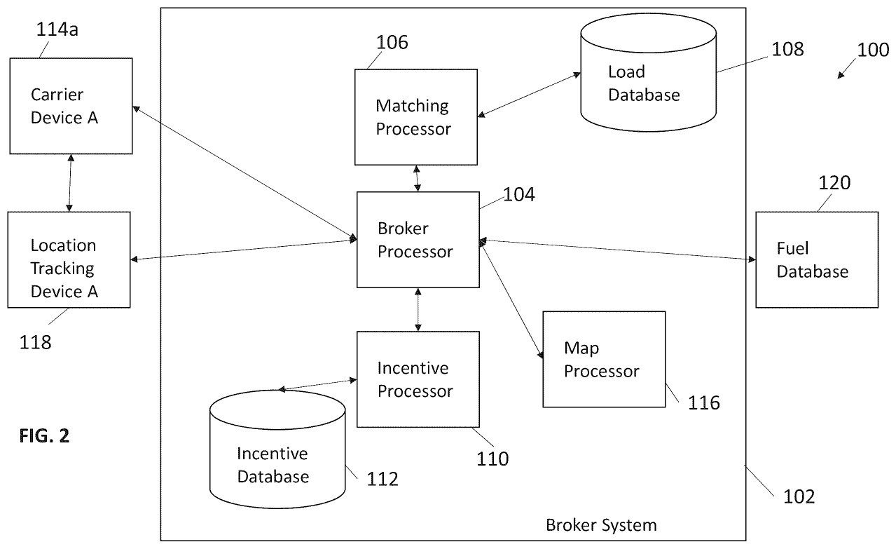

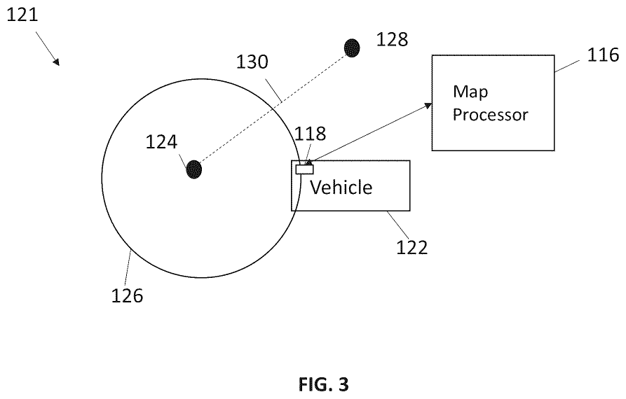

Referring now to FIG. 2, a non-limiting embodiment of the system 100 for managing supply chain is described below. The system may include the same or similar characteristics as the system from FIG. 1, and may include the following additional characteristics. Broker system 102 may further comprise a map processor 116 configured to generate a map 121 (see FIG. 3) and track a location of an object (e.g., a vehicle) on the map. The system 100 may comprise a fuel database 120 configured to determine a current fuel price, such as a national average fuel price or an average fuel price in a region and/or set of regions. The fuel database may also be configured to generate predictions about future fuel prices.

The system 100 may further comprise a location tracking device 118 of a vehicle of carrier A. The location tracking device 118 may be arranged on the vehicle and be capable of determining a location of the vehicle. For example, the location tracking device 118 may be a global positioning system (GPS) device capable of determining a coordinate location of the vehicle. The location tracking device 118 may continuously or periodically determine the location of the vehicle.

The system may optionally include a different location tracking device (not shown) arranged on the load (such as on the trailer being towed by the vehicle or on the products being shipped themselves).

Referring to FIGS. 2 and 3, a vehicle 122 may tow a load (e.g., Load 1) from an origin location of Load 1 to a destination location 124 of Load 1. For Load 1, map processor 116 may generate a geofence area 126 associated with Load 1 at least partially surrounding the destination location 124. The broker system 102, such as the map processor 116 may receive continuous or periodic location updates for vehicle 122 from the location tracking device 118 on the vehicle. The map processor 116 may track the location of the vehicle 122 based on the location data from the location tracking device 118.

In response to the map processor 116 determining (based on the location data of the vehicle 122) that the vehicle 122 has entered the geofence area 126, the map processor 116 may receive location data indicating the instant location of the vehicle 122 from the location tracking device 118. The map processor 116 may also determine the destination location 124 for Load 1 (which is the destination to which the vehicle 122 is traveling). The map processor 116 may estimate an arrival time at which the vehicle 122 is expected to arrive at the destination location 124.

Based on destination location 124, the broker system 102 (e.g., the matching processor 106) may query the load database 108 to determine at least one load request stored therein having an origin location 128 most proximate to the destination location 124. The matching processor 106 may determine a single load request that matches, by determining the closest origin location 128. Alternatively the matching processor 106 may determine a plurality of load requests that match based on the origin locations 128 being within a predetermined threshold distance of the destination location 124. For example, the matching processor 106 may determine that Load 3 having the origin location 128 may be the most proximate load in the load database 108 to destination location 124.

Based on determining that Load 3 is the most proximate load to the destination location 124, the broker system 102 may generate a load recommendation message that comprises a data field containing a third load identifier associated with Load 3 and load data associated therewith. If the matching processor 106 identifies a plurality of loads to recommend (based on the destination location 124 and origin locations 128), the load recommendation message may comprise a plurality of recommended load identifiers and bad data associated with each.

The broker system 102 may transmit the load recommendation message to carrier device A 114a to display data associated with Load 3 on carrier device A 114A. A selectable element may also be displayed on carrier device A 114 to enable Carrier A to accept and/or decline the recommendation of Load 3. In response to the selectable element being engaged on carrier device A to accept Load 3, carrier device A 114A may generate and transmit to the broker system a bad acceptance message containing an indicator that Carrier A has accepted Load 3. Carrier A may transport Load 3 from origin location 128 to its destination location using the vehicle 122.

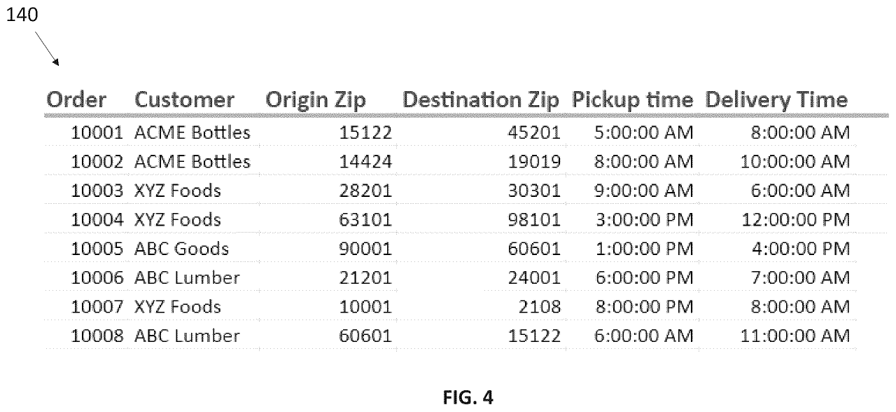

Referring to FIGS. 2 and 4, in some non-limiting embodiments or aspects, the broker processor 104 of the broker system 102 may automatically display on a user interface 140 of a broker device (not shown) data associated with each bad request. For example, as shown in FIG. 4, a list of loads received by the broker system 102 and stored in the load database 108 may be displayed on the user interface 140. In some non-limiting examples, the load data for each load displayed on the user interface 140 may include an identifier for each load (e.g., “Order”), a shipper name or identifier (e.g. “Customer”), an origin location (e.g., “Origin Zip”), a destination location (e.g., “Destination Zip”), a requested load pick-up time (e.g., “Pickup Time”), and a requested load delivery time (e.g., “Delivery Time”), and it will be appreciated that more or less data about the loads may be displayed on the user interface 140.

Referring to FIGS. 2-5C, in some non-limiting embodiments, in response to the matching processor 106 determining at least one load request stored in the load database 108 having an origin location 128 most proximate to the destination location 124 (e.g., Load 3), the broker processor 104 of the broker system 102 may automatically modify the user interface 140 to generate and display a modified user interface 150. The modified user interface 150 may emphasize a display associated with the load request(s) determined having an origin location 128 most proximate to the destination location 124. The user interface 150 emphasizing the display associated with recommended load request should be construed broadly to apply to any alteration to the user interface 140 that alters the user interface 140 in a region corresponding to the recommended load.

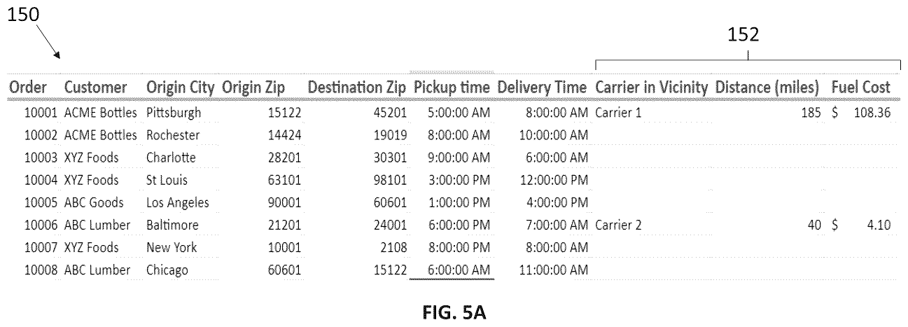

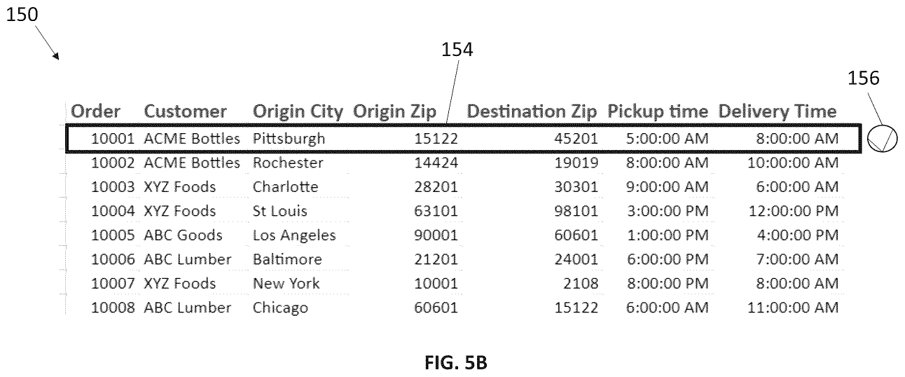

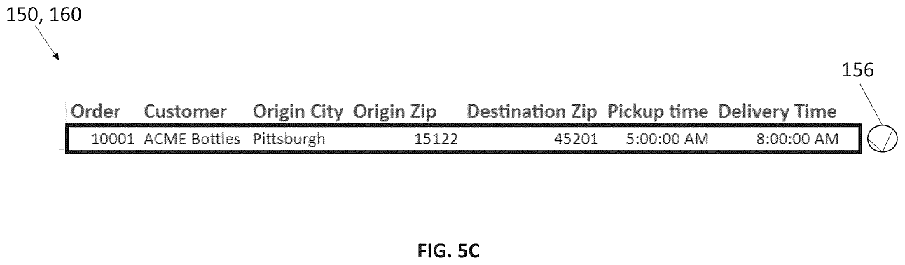

FIG. 5A shows a non-limiting example of emphasizing the display associated with recommended load by adding additional data 152 to the user interface 140 such that the modified user interface 150 includes the additional data in a region of the display corresponding to the recommended load. For example, the modified user interface 150 in FIG. 5A includes additional data fields, such as a field indicating a carrier in the vicinity of a load (as described above), a distance in miles between the destination location of the carrier and the origin location of the load, a fuel cost to the carrier to drive the vehicle 122 from the destination location of the carrier and the origin location of the load. It will be appreciated that other data may be included, such as an estimated time which the carrier could arrive at the origin location of the load, a recommended rate enhancement based on the vehicle 122 driving from the destination location of the carrier and the origin location of the load, an indicator as to whether the load should be recommended to the carrier (e.g. a selectable element to generate and communicate a load recommendation message), and the like.

FIG. 5B shows a non-limiting example of emphasizing the display associated with recommended load by visually modifying the user interface 140 such that the modified user interface 150 includes a visual modification 154 in a region of the display corresponding to the recommended load. In the example of FIG. 5B, the visual modification 154 in the region of the display corresponding to the recommended load includes a box around the recommended load, although it will be appreciated by that other visual modifications could be used, such as highlighting the recommended load, de-emphasizing the non-recommended loads, isolating the recommended loads, bolding the recommended loads, and the like. The modified user interface 150 may further comprise a selectable element 156 that enables the broker device to select the load for inclusion in the load recommendation message.

FIG. 5C shows a non-limiting example of emphasizing the display associated with recommended load by modifying the user interface 140 by generating and displaying a new user interface as the modified user interface 150. The modified user interface may contain only the recommended loads and omit the non-recommended loads. The modified user interface 150 may further comprise a selectable element 156 that enables the broker device to select the load for inclusion in the load recommendation message.

Referring again to FIGS. 2 and 3, in some non-limiting embodiments or aspects, the system 100 may determine a travel distance 130 for the vehicle 122 between the origin location 128 of the third load and the destination location 124 of Load 1 (e.g., such as using the map processor 116). The broker system 104 may communicate with the fuel database to retrieve a real-time fuel rate 120 (fuel rate at the time of the communication with the fuel database 120). The broker system 102 may also determine a fuel efficiency of the vehicle 122 based on vehicle data associated with the vehicle 122 (which may be received from carrier device A 114a). Based on the based on the travel distance 130, the real-time fuel rate, and the fuel efficiency of the vehicle 122, the broker system 122 may determine a deadhead cost associated with the vehicle 122 traveling from the destination location 124 to the origin location 128 of Load 3.

Based on the deadhead cost, the broker system 102 may automatically update the third rate and/or the enhanced third rate. For example, if the deadhead cost is $100, the third rate and/or the enhanced third rate may be increased by $100 or some percentage thereof to account for Carrier A's expenses for arriving at the origin location 128 of Load 3.

With continued reference to FIGS. 2 and 3, in some non-limiting embodiments, the broker system 102 may execute the following for each load request identified by the matching processor 106 and/or map processor 116 as being most proximate to the destination location 124 of Load 1 (as previously described). The broker system 102 may determine the deadhead cost for each load request as previously described (e.g. based on the destination location 124 and each origin location 128 of the proximate loads). The determined deadhead costs for each proximate load may be compared to a threshold associated with a load price corresponding to the load request (e.g., the load price specified by the shipper of the load). For each load request in which the threshold is not satisfied, the load request may be inserted into the load recommendation message to be transmitted to carrier device A 114a. For example, the threshold may be satisfied if the deadhead amount causes the third rate or enhanced third rate due to Carrier A for completing Load A to exceed the load price (e.g., less a minimum margin specified by the broker system 102), such that the load should not be recommended due to the excessive deadhead cost and/or deficient load price. For example, the threshold may not be satisfied if the deadhead amount does not cause the third rate or enhanced third rate due to Carrier A for completing Load A to exceed the load price (e.g., less a minimum margin specified by the broker system 102), such that the load should be recommended due to the feasibility of working within the load price.

As previously described, FIGS. 2-5C may correspond to user interfaces 104 or modified user interfaces 150 displayed on a device of the broker system 102. However, it will be appreciated that FIGS. 4-5C may correspond to user interfaces 104 or modified user interfaces 150 displayed on a device of a carrier (e.g., carrier device A 114a). For example, storing each load request in the load database 108 may further comprises automatically uploading each load request to an online portal accessible to carrier device A 114 to cause each of the loads to be displayed on a user interface of carrier device A. This may enable the carriers to view loads of the broker system available for selection. Using the same process as previously described, the user interface 140 of carrier device A 114a may be modified to form the modified user interface so that loads recommended for Carrier A may be emphasized on the display. This may allow Carrier A to efficiently identify loads from the plurality of displayed loads that may be recommended for the vehicle 122 that has entered the geofence area 126 at a particular time proximate the vehicle's 122 arrival at the destination 124 of Load 1. This may enhance management of the supply chain by more quickly and efficiently matching carriers to shippers, which may be done using reduced processing resources.

The selectable element 156 displayed on the modified user interface 150 of carrier device A 114a (see e.g., FIGS. 5B-5C) may enable the Carrier A to interact with the modified user interface 150 to accept Load 3, such as by communicating a load acceptance message to the broker system 102 in repose to Carrier A engaging the selectable element 156.

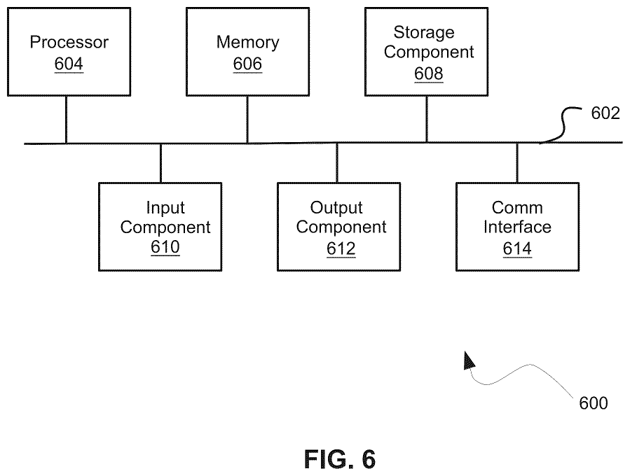

Referring now to FIG. 6, shown is a diagram of example components of a device 600 according to non-limiting embodiments or aspects. Device 600 may correspond to any of the devices (e.g., devices and/or processors) shown in FIG. 1, as an example. In some non-limiting embodiments or aspects, such systems or devices may include at least one device 600 and/or at least one component of device 600. The number and arrangement of components shown are provided as an example. In some non-limiting embodiments or aspects, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

As shown in FIG. 6, device 600 may include a bus 602, a processor 604, memory 606, a storage component 608, an input component 610, an output component 612, and a communication interface 614. Bus 602 may include a component that permits communication among the components of device 600. In some non-limiting embodiments or aspects, processor 604 may be implemented in hardware, firmware, or a combination of hardware and software. For example, processor 604 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 606 may include random access memory (RAM), read only memory (ROM), and/or another type of dynamic or static storage device (e.g., flash memory, magnetic memory, optical memory, etc.) that stores information and/or instructions for use by processor 604.

With continued reference to FIG. 6, storage component 608 may store information and/or software related to the operation and use of device 600. For example, storage component 608 may include a hard disk (e.g., a magnetic disk, an optical disk, a magneto-optic disk, a solid state disk, etc.) and/or another type of computer-readable medium. Input component 610 may include a component that permits device 600 to receive information, such as via user input (e.g., a touch screen display, a keyboard, a keypad, a mouse, a button, a switch, a microphone, etc.). Additionally, or alternatively, input component 610 may include a sensor for sensing information (e.g., a global positioning system (GPS) component, an accelerometer, a gyroscope, an actuator, etc.). Output component 612 may include a component that provides output information from device 600 (e.g., a display, a speaker, one or more light-emitting diodes (LEDs), etc.). Communication interface 614 may include a transceiver-like component (e.g., a transceiver, a separate receiver and transmitter, etc.) that enables device 600 to communicate with other devices, such as via a wired connection, a wireless connection, or a combination of wired and wireless connections. Communication interface 614 may permit device 600 to receive information from another device and/or provide information to another device. For example, communication interface 614 may include an Ethernet interface, an optical interface, a coaxial interface, an infrared interface, a radio frequency (RF) interface, a universal serial bus (USB) interface, a Wi-FI® interface, a cellular network interface, and/or the like.

Device 600 may perform one or more processes described herein. Device 600 may perform these processes based on processor 604 executing software instructions stored by a computer-readable medium, such as memory 606 and/or storage component 608. A computer-readable medium may include any non-transitory memory device. A memory device includes memory space located inside of a single physical storage device or memory space spread across multiple physical storage devices. Software instructions may be read into memory 606 and/or storage component 608 from another computer-readable medium or from another device via communication interface 614. When executed, software instructions stored in memory 606 and/or storage component 608 may cause processor 604 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

### EXAMPLES

### Example 1

The following is a non-limiting example of the disclosure described herein. The disclosure is not limited to the examples described herein.

As an example, MC000001 regularly hauls a van load from Boston to Chicago. The market rate for this lane is $1,500. The broker system was given $1700 by the load device to move a load of lumber from Boston to Chicago. The broker system has 3 of these loads per week from this shipper. The broker system communicates with carrier device A to determine if Carrier A would like to be enrolled in the incentive program. Carrier device A accepts the enrollment request and the broker system pays Carrier A (assigned incentive number MC000001) $1400 to haul one load. MC000001 then refers Carrier B (later assigned incentive number MC000002) to the broker system. MC000002 accepts and completes the shipment of a load of apples from Buffalo to Dallas the broker system had posted on a universal load board (e.g., a website). The market rate is 52000 and the broker system receives $2400 from the shipper to cover the load. The broker system enrolls Carrier B (MC000002) in the incentive program. Carrier B completes the load for $1800. Both carriers are enrolled in the incentive program but one carrier was referred by another.

In this example, Carrier A would be automatically rewarded an incentive for referring a Carrier B that hauled a load with the broker system. The incentive could be applied during the next load that Carrier A hauls. For example, if Carrier A were to haul the same load as before, the rate would be enhanced (1400+incentive or $1402). MC000001 (e.g., the identifier) may have been identified by MC000002 in the load acceptance message in which Carrier B accepted the second load from the broker system.

The incentive calculation may be subject to the amount of risk each broker system wants to assume. The system may operate as a compounding incentive, meaning for every load a carrier refers, the rate may be compounded on a per load basis. Upon enrolling in the incentive program, a carrier may agree to variable terms in order to establish a “locked in” starting rate. This rate may be a percentage above or below the market rate. These variables may be subjective but can reflect the carrier's commitment to the broker system. If a carrier wants a higher starting rate, the incentive may be lower per load, or the carrier can subscribe to a lower rate with a higher incentive. There is also a time factor as well. A carrier can agree to a starting rate as well as an incentive and only be committed for a certain amount of time. For example, there may be a load count or a set time period that during which the incentive must be maxed out.

With this incentive structure, pyramid schemes may be avoided as follows. A contingency of this system may be that a one lateral layer of incentive limit is imposed. If MC000001 refers MC000002, then MC000001 receives an incentive. If MC000002 refers MC000003, then only MC000002 receives the incentive and not MC000001. There may, therefore, be a direct referral within one layer of lateral movement. Upon enrolling in the inventive program, the broker system may notify carriers of such limitations and prohibit multi-level referrals. This contingency creates a greater inflow of carriers without increasing incentive beyond profit margins.

Spot bidding for broker systems often requires a long-term commitment. The amount of loads a customer wants to submit for bidding can vary anywhere from one immediate, to many long term load. When bidding on these loads, broker systems may estimate the rate that they will be paying carriers in the future. Given the nature of volatile markets, the further out a broker system bids, the less accurate it may be in its estimates.

Given the nature of the incentive structure, the equation created to determine the enhanced rate due to a carrier for referring other carriers can have multiple applications. To determine a proper incentive amount, a forecasted dollar amount can be calculated based on a compounding rate. The equation can also be used to forecast future market conditions to a certain capacity. With the ability to forecast how much a carrier is paid based on how many loads he runs and is incentivized, broker systems can use that equation to narrow down what market rates will be in a set amount of time. Given the Efficient Market theory, the market cannot be predicted to an exact amount, but the incentive calculations give broker systems more tools to determine market predictions.

Where the equation may be implemented is in the spot bid market. A brief example is if a customer asks a broker system to provide a rate for the next six months or next 100 loads. The broker system may place a bid based on what the broker system can cover and what the broker systems will still be able to cover in that extended time frame. Using forecasted numbers from the incentive, the broker system will be able to more accurately predict what the market rate will be, thus enabling more educated long-term bids. This will vastly influence future market bids and enable broker systems and carriers to calculate profits more precisely.

Regardless if the equation predicts market rates, it still gives the broker system a more concrete baseline as to what individual carriers will be paid. By the time the carrier rapport is developed, the broker system may be able to track historical data on each MC number. Using that information, the broker system can then determine what rate a carrier will be paid in a certain amount of loads. By gathering the data from historical transactions, it creates consistency in data information, all stored by a database of the broker system, to determine how much a carrier will be paid in a forecasted amount of time.

In summary, the disclosure describes a system for managing supply chain determined by a broker system, which may include an incentive program. Internal software can provide standards to carriers to select to which incentive package they would like to subscribe. Carriers can be incentivized on a per load basis which is compounded based on the amount of carriers they refer to the broker system. Internal broker system databases link MC numbers (unique identifiers) together to establish a one-layer deep level of automatic incentive to increase the amount of carriers calling into the broker system whilst taking stress off the broker system to cover loads on a transactional basis and create a rapport with each carrier.

### Example 2

Carrier MC number 123456 currently is on a load from zip codes 14424 to 15282. Carrier is tracking with electronic logging device (ELD) location and broker knows the driver will be at the delivery location in approximately two hours based on the ELD location data. Carrier does not have another load scheduled. The system including broker internal system, scans the internal system for loads according to zip code. The system recognizes that there is a load picking up in zip code 16501 going to zip code 14424. The current market rate for lane zip codes 16501 to 14424 is $1,000. The distance between the delivery zip code and pickup zip code is 100 miles. The broker receives $1,500 from the customer to move the load. The system determines the cost of fuel for the empty miles by pulling current diesel prices from an external source (e.g., either AAA or EIA) and determines the price of fuel is $5/gallon. The software determines the cost of fuel for the carrier by dividing the total mileage by an average mpg in a truck (typically 6-8 MPG) and multiplies the national average by the gallons required. The driver will spend roughly $85 in fuel for the deadhead miles ((100/7*)*5=83.33). The broker system then can determine it will be profitable if he pays the driver for the empty miles and the current rate. Broker system will pay carrier $1083 based on market rates and deadhead miles and the broker system will realize the rest in margin.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method, comprising:
receiving, with at least one processor, a plurality of bad requests from a plurality of devices associated with a plurality of shippers, each bad request of the plurality of load requests comprising a shipper identifier, an origin location, and a destination location, wherein the plurality of bad requests comprise a first bad, a second bad, and a third bad;
storing, with a least one processor, each bad request in a bad database;
receiving, with at least one processor, a first bad acceptance message from a device associated with a first carrier, the first bad acceptance message comprising a first carrier identifier, a first bad identifier, and a first rate;
automatically enrolling the first carrier in a first program, wherein enrolling the first carrier comprises storing a first incentive identifier associated with the first carrier in an incentive database;
receiving, with at least one processor, a second bad acceptance message from a device associated with a second carrier different from the first carrier, the second bad acceptance message comprising a second carrier identifier, a second bad identifier, the first incentive identifier associated with the first carrier, and a second rate;
in response to receiving the second bad acceptance message comprising the first incentive identifier, storing and associating, with at least one processor, at least one credit with the first carrier in the incentive database;
receiving, with at least one processor, a third bad acceptance message from the device associated with the first carrier, the third bad acceptance message comprising the first carrier identifier, a third bad identifier, and a third rate;
in response to receiving the third bad acceptance message and based on the at least one credit associated with the first carrier in the incentive database, modifying, with at least one processor, the third rate by increasing the third rate to an enhanced third rate.

2. The computer-implemented method of claim 1, further comprising:
receiving, with at least one processor, a fourth load acceptance message from a device associated with a third carrier different from the first carrier, the fourth load acceptance message comprising a third carrier identifier, a fourth load identifier, the first incentive identifier associated with the first carrier, and a fourth rate;
in response to receiving the fourth bad acceptance message comprising the first incentive identifier, storing and associating, with at least one processor, at least one credit with the first carrier in the incentive database.

3. The computer-implemented method of claim 1, further comprising:
automatically enrolling the second carrier in the first program, wherein enrolling the second carrier comprises storing a second incentive identifier associated with the second carrier in the incentive database;
receiving, with at least one processor, a fourth bad acceptance message from a device associated with a third carrier different from the second carrier, the fourth bad acceptance message comprising a third carrier identifier, a fourth load identifier, the second incentive identifier, and a fourth rate;
in response to receiving the fourth load acceptance message comprising the second incentive identifier, storing and associating, with at least one processor, at least one credit with the second carrier in the incentive database.

4. The computer-implemented method of claim 1, wherein the third rate is increased to the enhanced third rate according to: A=P(1+r/n)^{nt}
wherein A is the enhanced third rate, P is the third rate, r is an incentive rate, n is a credit per load, and t is a number of loads referred by the first carrier.

5. The computer-implemented method of claim 1, wherein storing each bad request in a bad database further comprises automatically uploading each bad request to an online portal accessible to devices of a plurality of carriers.

6. The computer-implemented method of claim 1, further comprising:
in response to a first vehicle of the first carrier entering a geofence area associated with a first destination location associated with the first load, receiving, with at least one processor, location data of the first vehicle, wherein the first vehicle comprises a location tracking device;
in response to receiving the location data of the first vehicle, determining, with at east one processor, the first destination location;
based on the first destination location, querying, with at least one processor, the load database to determine at least one bad request of the plurality of bad requests having an origin location most proximate to the first destination location, wherein the at least one bad request having the origin location most proximate to the first destination location comprises the third load;
generating, with at least one processor, a load recommendation message comprising the third load identifier associated with the third load;
transmitting, with at least one processor, the load recommendation message to the device associated with the first carrier; and
receiving, with at least one processor, the third bad acceptance message,

7. The computer-implemented method of claim 6, wherein the at least one processor displays a user interface showing each bad request on a broker device, wherein the method further comprises:
in response to determining the at least one load request of the plurality of load requests having an origin location most proximate to the first destination location, modifying the user interface to emphasize a display associated with the at least one load request of the plurality of load requests.

8. The computer-implemented method of claim 7, wherein emphasizing the display associated with the at least one load request of the plurality of load requests comprises generating and displaying a new user interface containing only the at least one load request of the plurality of load requests.

9. The computer-implemented method of claim 6, further comprising:
determining, with at least one processor, a travel distance between an origin location of the third load and the first destination location;
retrieving, with at least one processor, a real-time fuel rate and a fuel efficiency of the first vehicle;
based on the travel distance, the real-time fuel rate, and the fuel efficiency of the first vehicle, determining, with at least one processor, a deadhead cost associated with the first vehicle traveling from the first destination location to the origin location of the third load; and
automatically updating, with at least one processor, at least one of the third rate and the enhanced third rate based on the determined deadhead cost.

10. The computer-implemented method of claim 6, further comprising:
for each of the at least one load request having an origin location most proximate to the first destination location:
determining, with at least one processor, a deadhead cost associated with the first vehicle traveling from the first destination location to the origin location of each of the at least one load request having an origin location most proximate to the first destination location; and
comparing each deadhead cost to a threshold related to a bad price for the corresponding load request;
for each bad request in which the threshold is not satisfied, inserting the bad request into the bad recommendation message.

11. The computer-implemented method of claim 6, wherein storing each bad request in a bad database further comprises automatically uploading each bad request to an online portal accessible to devices of a plurality of carriers to cause each of the loads to be displayed on a second user interface of the device associated with the first carrier, wherein the method further comprises:
in response to determining the at least one bad request of the plurality of bad requests having an origin location most proximate to the first destination location, modifying the second user interface to emphasize a display associated with the at least one load request of the plurality of load requests.

12. The computer-implemented method of claim 11, wherein the emphasized display associated with the at least one load request of the plurality of load requests enables the first carrier to interact with the second user interface to accept the at least one load request of the plurality of load requests.

13. A system comprising at least one processor programmed or configured to:
receive a plurality of load requests from a plurality of devices associated with a plurality of shippers, each load request of the plurality of load requests comprising a shipper identifier, an origin location, and a destination location, wherein the plurality of load requests comprise a first load, a second load, and a third load;
store each load request in a load database;
receive a first load acceptance message from a device associated with a first carrier, the first load acceptance message comprising a first carrier identifier, a first load identifier, and a first rate;
automatically enroll the first carrier in a first program, wherein enrolling the first carrier comprises storing a first incentive identifier associated with the first carrier in an incentive database;
receive a second load acceptance message from a device associated with a second carrier different from the first carrier, the second load acceptance message comprising a second carrier identifier, a second load identifier, the first incentive identifier associated with the first carrier, and a second rate;
in response to receiving the second load acceptance message comprising the first incentive identifier, store and associate, with at least one processor, at least one credit with the first carrier in the incentive database;
receive, with at least one processor, a third load acceptance message from the device associated with the first carrier, the third load acceptance message comprising the first carrier identifier, a third load identifier, and a third rate;
in response to receiving the third load acceptance message and based on the at least one credit associated with the first carrier in the incentive database, modify, with at least one processor, the third rate by increasing the third rate to an enhanced third rate.

14. The system of claim 13, further comprising:
receiving, with at least one processor, a fourth load acceptance message from a device associated with a third carrier different from the first carrier, the fourth load acceptance message comprising a third carrier identifier, a fourth load identifier, the first incentive identifier associated with the first carrier, and a fourth rate;
in response to receiving the fourth load acceptance message comprising the first incentive identifier, storing and associating, with at least one processor, at least one credit with the first carrier in the incentive database.

15. The system of claim 13, wherein the at least one processor is further programmed or configured to:
automatically enroll the second carrier in the first program, wherein enrolling the second carrier comprises storing a second incentive identifier associated with the second carrier in the incentive database;
receive a fourth load acceptance message from a device associated with a third carrier different from the second carrier, the fourth load acceptance message comprising a third carrier identifier, a fourth load identifier, the second incentive identifier, and a fourth rate;
in response to receiving the fourth load acceptance message comprising the second incentive identifier, store and associate at least one credit with the second carrier in the incentive database.

16. The system of claim 13, wherein the third rate is increased to the enhanced third rate according to: A=P(1+r/n)^{nt}
wherein A is the enhanced third rate, P is the third rate, r is an incentive rate, n is a credit per load, and t is a number of loads referred by the first carrier.

17. The system of claim 13, wherein storing each load request in a load database further comprises automatically uploading each load request to an online portal accessible to devices of a plurality of carriers,

18. The system of claim 13, wherein the at east one processor is further programmed or configured to:
in response to a first vehicle of the first carrier entering a geofence area associated with a first destination location associated with the first load, receive location data of the first vehicle, wherein the first vehicle comprises a location tracking device;
in response to receiving the location data of the first vehicle, determine the first destination location;
based on the first destination location, query the load database to determine at least one load request of the plurality of load requests having an origin location most proximate to the first destination location, wherein the at least one load request having the origin location most proximate to the first destination location comprises the third load;
generate a load recommendation message comprising the third load identifier associated with the third load;
transmit the load recommendation message to the device associated with the first carrier; and
receive the third load acceptance message.

19. The system of claim 18, wherein the at least one processor displays a user interface showing each load request on a broker device, wherein the at least one processor is further programmed or configured to:
in response to determining the at least one load request of the plurality of load requests having an origin location most proximate to the first destination location, modify the user interface to emphasize a display associated with the at least one load request of the plurality of load requests.

20. A computer program process comprising at least one non-transitory computer-readable medium including one or more instructions that, when executed by at least one processor, cause the at least one processor to:
receive a plurality of load requests from a plurality of devices associated with a plurality of shippers, each load request of the plurality of load requests comprising a shipper identifier, an origin location, and a destination location, wherein the plurality of load requests comprise a first load, a second load, and a third load;
store each load request in a load database;
receive a first load acceptance message from a device associated with a first carrier, the first load acceptance message comprising a first carrier identifier, a first load identifier, and a first rate;
automatically enroll the first carrier in a first program, wherein enrolling the first carrier comprises storing a first incentive identifier associated with the first carrier in an incentive database;
receive a second load acceptance message from a device associated with a second carrier different from the first carrier, the second load acceptance message comprising a second carrier identifier, a second load identifier, the first incentive identifier associated with the first carrier, and a second rate;
in response to receiving the second load acceptance message comprising the first incentive identifier, store and associate, with at least one processor, at least one credit with the first carrier in the incentive database;
receive, with at least one processor, a third load acceptance message from the device associated with the first carrier, the third load acceptance message comprising the first carrier identifier, a third load identifier, and a third rate;
in response to receiving the third load acceptance message and based on the at least one credit associated with the first carrier in the incentive database, modify, with at least one processor, the third rate by increasing the third rate to an enhanced third rate.
